(19) United States
(12) Patent Application Publication
(10) Pub. No.: US 2025/0008516 A1
(43) Pub. Date: Jan. 2, 2025

(54) METHOD AND APPARATUS FOR PHYSICAL DOWNLINK CONTROL CHANNEL (PDCCH) AND CHANNEL STATE INFORMATION (CSI)-REFERENCE SIGNAL(RS) MONITORING

(71) Applicant: Lenovo (Beijing) Limited, Beijing (CN)

(72) Inventors: Yi Zhang, Beijing (CN); Chenxi Zhu, Fairfax, VA (US); Bingchao Liu, Beijing (CN); Wei Ling, Beijing (CN); Lingling Xiao, Beijing (CN)

(73) Assignee: Lenovo (Beijing) Limited, Beijing (CN)

(21) Appl. No.: 18/291,092

(22) PCT Filed: Jul. 30, 2021
(86) PCT No.: PCT/CN2021/109658

§ 371 Date: Jan. 22, 2024

(51) Int. Cl. H04W 72/23; H04L 5/00

(52) U.S. Cl. CPC H04W 72/23; H04L 5/0048

(57) ABSTRACT

Embodiments of the present application relate to a method and apparatus for physical downlink control channel (PDCCH) and channel state information (CSI)-reference signal (RS) monitoring. An exemplary method may include: receiving configuration information for monitoring PDCCH, wherein the configuration information for monitoring PDCCH indicates at least one search space set configured in a set of OFDM symbol: receiving configuration information of CSI-RS, wherein the configuration information of CSI-RS indicates at least one CSI-RS configured in the set of OFDM symbol; and monitoring the at least one search space set and the at least one CSI-RS in the set of OFDM symbol based on one of the following: a configuration restriction rule on QCL-TypeD of CSI RS in view of CORESET in a same OFDM symbol; and a monitoring rule for monitoring PDCCH and CSI-RS with different QCL-TypeDs in a same OFDM symbol.

### TECHNICAL FIELD

Embodiments of the present application are related to wireless communication technology, especially, related to a method and apparatus for physical downlink control channel (PDCCH) and channel state information (CSI)-reference signal (RS) monitoring, e.g., during multiple transmit-receive point (TRP) transmission.

### BACKGROUND OF THE INVENTION

Multi-TRP/panel transmission has been introduced into new radio (NR) since Release 16 (R16), and enhancements on multiple-input multiple-output (MIMO) for NR have been discussed, for example in RP-182067. During multi-TRP transmission, two or more TRPs (or panels) may be used to transmit data to a user equipment (UE) to improve reliability and robustness. For that, PDCCH is being enhanced in NR R17. For example, a work item description (WID) approved on MIMO in NR R17 includes a research topic, which identify and specify features to improve reliability and robustness for channels other than PDSCH (that is, PDCCH, PUSCH, and PUCCH) using multi-TRP and/or multi-panel, with Rel.16 reliability features as the baseline. Simultaneous reception of PDCCH with different transmission configuration indicator (TCI) states including different quasi co-location (QCL)-TypeDs is one kind of such enhancement for PDCCH.

In addition, for a UE with multiple panels, it has the capability of receiving transmission(s) with multiple QCL-TypeDs in the same orthogonal frequency division multiplexing (OFDM) symbol(s). However, according to current 3rd generation partnership project (3GPP) specification(s), a UE will assume that CSI-RS and PDCCH have the same QCL-TypeD when the UE is configured with CSI-RS resource(s) and search space sets of PDCCH in the same OFDM symbol(s). That is, the UE cannot support receiving PDCCH and CSI-RS with different QCL-TypeDs (or different QCL-TypeD properties) in the same OFDM symbol(s).

Thus, to exploit the enhanced capability of UE for receiving transmission(s) with multiple QCL-TypeDs in the same OFDM symbol(s), the technical problem potentially caused by PDCCH and CSI-RS in the same OFDM symbol(s) should be solved.

### SUMMARY

One objective of the embodiments of the present application is to provide a technical solution for PDCCH and CSI-RS monitoring in the same time unit, especially for PDCCH and CSI-RS monitoring during multi-TRP transmission.

Some embodiments of the present application provide a method, which includes: receiving configuration information for monitoring PDCCH, wherein the configuration information for monitoring PDCCH indicates at least one search space set configured in a set of OFDM symbol, and a set of CORESET associated with the at least one search space set at least includes a CORESET with a plurality of activated TCI states or at least includes two frequency division multiplexing (FDM)-ed CORESETs; receiving configuration information of CSI-RS, wherein the configuration information of CSI-RS indicates at least one CSI-RS configured in the set of OFDM symbol; and monitoring the at least one search space set and the at least one CSI-RS in the set of OFDM symbol based on one of the following: a configuration restriction rule on QCL-TypeD of CSI RS in view of CORESET in a same OFDM symbol; and a monitoring rule for monitoring PDCCH and CSI-RS with different QCL-TypeDs in a same OFDM symbol. In some embodiments of the present application, the method may include: reporting a capability signaling indicating whether capable of receiving with different QCL-TypeDs in one or more same OFDM symbols in a UE.

Some embodiments of the present application provide another method, which includes: transmitting configuration information for monitoring PDCCH, wherein the configuration information for monitoring PDCCH indicates at least one search space set configured in a set of OFDM symbols, and a set of CORESET associated with the at least one search space set at least includes a CORESET with a plurality of activated TCI states or at least includes two FDM-ed CORESETs; transmitting configuration information of CSI-RS, wherein the configuration information of CSI-RS indicates at least one CSI-RS configured in the set of OFDM symbol; wherein the configuration information for monitoring PDCCH and configuration information of CSI-RS is configured based on one of the following: a configuration restriction rule on QCL-TypeD of CSI RS in view of CORESET in a same OFDM symbol; and a monitoring rule for monitoring PDCCH and CSI-RS with different QCL-TypeDs in a same OFDM symbol. In some embodiments of the present application, the method may include: receiving a capability signaling indicating whether capable of receiving with different QCL-TypeDs in one or more same OFDM symbols in a UE.

In some embodiments of the present application, the configuration restriction rule defines that: a QCL-TypeD of a CSI-RS to be monitored is as the same as one QCL-TypeD of a CORESET with a plurality of activated TCI states in the case that the CSI-RS and one or more search space sets associated with the CORESET are configured in the same OFDM symbol; or a QCL-TypeD of a CSI-RS to be monitored is as the same as a QCL-TypeD of a CORESET of a plurality of FDM-ed CORESETs in the case that the CSI-RS and one or more search space sets associated with the plurality of CORESETs are configured in the same OFDM symbol.

In some other embodiments of the present application, the configuration restriction rule defines that: a QCL-TypeD of a CSI-RS to be monitored is as the same as a QCL-TypeD of a search space set with a highest priority of one or more search space sets in the case that the CSI-RS and the one or more search space sets are configured in the same OFDM symbol. According to some embodiments of the present application, the search space set with the highest priority is a common search space set with a lowest identity if existed, otherwise is a UE specific search space set with a lowest identity.

In some embodiments of the present application, the monitoring rule defines: monitoring PDCCH with assumption of a QCL-TypeD and monitoring CSI-RS with assumption of another QCL-TypeD. According to some embodiments of the present application, the QCL-TypeD assumed for monitoring PDCCH is associated with a CSI-RS resource set or a sounding reference signal (SRS) resource set and the other QCL-TypeD assumed for monitoring CSI-RS is associated with another CSI-RS resource sets or another SRS resource set.

In some other embodiments of the present application, the monitoring rule defines only monitoring PDCCH while not monitoring any CSI-RS with a QCL-TypeD different from the PDCCH in the same OFDM symbol. According to some embodiments of the present application, in the case that a CSI-RS with the different QCL-TypeD is from a CSI-RS resource set, the monitoring rule also defines not monitoring any other CSI-RS of the CSI-RS resource set even if being configured in a different OFDM symbol.

In some yet other embodiments of the present application, the monitoring rule defines a priority list for monitoring PDCCH and CSI-RS. The monitoring rule may define a priority for monitoring PDCCH is higher than monitoring CSI-RS. According to some embodiments of the present application, elements of the priority list include a plurality of CSI-RSs, and a plurality of CORESETs or a plurality of search space sets. In the case that more than one search space set of the plurality of search space sets is linked, the more than one search space set has a same priority.

Some yet other embodiments of the present application also provide an apparatus, including: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry. The computer-executable instructions cause the at least one processor to implement any method according to an embodiment of the present application with the at least one receiving circuitry and the at least one transmitting circuitry.

Embodiments of the present application can solve the technical problem concerning on PDCCH and CSI-RS monitoring, especially in the case that the search space sets for PDCCH and CSI-RS are configured in the same OFDM symbol(s) during multi-TRP transmission, and thus will increase scheduling flexibility for PDCCH and CSI-RS transmission and facilitate the deployment and implementation of the NR.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 is a schematic diagram illustrating an exemplary wireless communication system according to some embodiments of the present application;

FIG. 2 illustrates a flow chart of a method for PDCCH and CSI-RS monitoring according to some embodiments of the present application;

FIG. 3 is a schematic diagram illustrating exemplary PDCCH and CSI-RS configured in the same set of OFDM symbol based on a configuration restriction rule according to some embodiments of the present application;

FIG. 4 is a schematic diagram illustrating exemplary PDCCH and CSI-RS configured in the same set of OFDM symbol based on a configuration restriction rule according to some other embodiments of the present application;

FIG. 5 is a schematic diagram illustrating exemplary PDCCH and CSI-RS configured in the same set of OFDM symbol based on a configuration restriction rule according to some embodiments of the present application;

FIG. 6 is a schematic diagram illustrating exemplary PDCCH and CSI-RS configured in the same set of OFDM symbol based on a configuration restriction rule according to some embodiments of the present application;

FIG. 7 is a schematic diagram illustrating exemplary PDCCH and CSI-RS configured in the same set of OFDM symbol based on a monitoring rule according to some embodiments of the present application; and

FIG. 8 illustrates a simplified block diagram of an apparatus for PDCCH and CSI-RS monitoring according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as the 3GPP 5G (NR), 3GPP long-term evolution (LTE) Release 8, and so on. It is contemplated that along with the developments of network architectures and new service scenarios, all embodiments in the present application are also applicable to similar technical problems; and moreover, the terminologies recited in the present application may change, which should not affect the principle of the present application.

A wireless communication system generally includes one or more base stations (BSs) and one or more UE. Furthermore, a BS may be configured with one TRP (or panel) or more TRPs (or panels). A TRP can act like a small BS. The TRPs can communicate with each other by a backhaul link. Such backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

In a wireless communication system, a single TRP can be used to serve one or more UE under the control of a BS. In different scenarios, a TRP may be referred to as different terms. Persons skilled in the art should understand that as 3GPP and the communication technology develop, the terminologies recited in the specification may change, which should not affect the scope of the present application. It should be understood that the TRP(s) (or panel(s)) configured for the BS may be transparent to a UE.

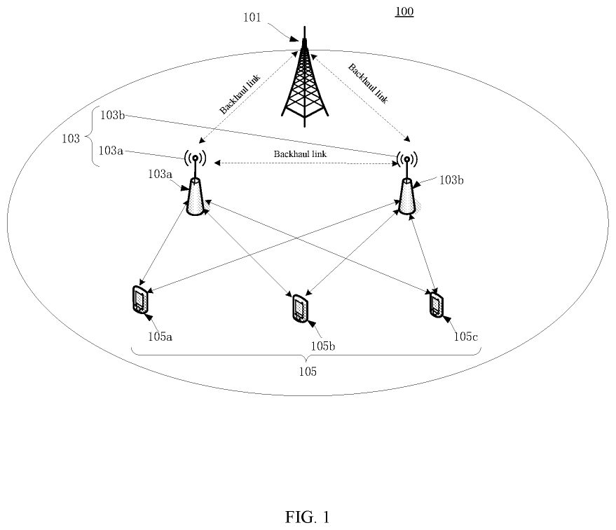

FIG. 1 is a schematic diagram illustrating an exemplary wireless communication system 100 according to some embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks. In an OFDM or OFDMA wireless communication system, the radio resource is partitioned into subframes, each of which may contain one or more time slots. Each slot may be consisted of a number of OFDM symbols, e.g. 14 symbols and the time length for an OFDM symbol depends on subcarrier spacing. Whether the granularity of OFDM symbols in the network side and remote side are identical or different dependent on the subcarrier spacing between different subcarriers. For example, the subcarrier spacing for CSI-RS and PDCCH may be different. In this case, corresponding OFDM symbol length for CSI-RS and PDCCH transmission is different. Partial overlapping between CSI-RS and PDCCH in time domain is also within the scope of embodiments of the present application.

Referring to FIG. 1, a wireless communication system 100 can include a base station (BS) 101, TRPs 103 (e.g., a TRP 103a and a TRP 103b), and UE 105 (e.g., a UE 105a, a UE 105b, and a UE 105c). Although only one base station 101, two TRPs 103 and three UE 105 are shown for simplicity, it should be noted that the wireless communication system 100 may include more or less communication device(s) or apparatus in accordance with some other embodiments of the present application.

In some embodiments of the present application, a BS 101 may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. The BS 101 is generally part of a radio access network that may include a controller communicably coupled to the BS 101.

The TRPs 103, for example, the TRP 103a and the TRP 103b can communicate with the base station 101 via, for example, a backhaul link. Each of TRPs 103 can serve some or all of UE 105. As shown in FIG. 1, the TRP 103a can serve some mobile stations (which include the UE 105a, the UE 105b, and the UE 105c) within a serving area or region (e.g., a cell or a cell sector). The TRP 103b can serve some mobile stations (which include the UE 105a, the UE 105b, and the UE 105c) within a serving area or region (e.g., a cell or a cell sector). The TRP 103a and the TRP 103b can communicate to each other via, for example, a backhaul link. The multi-TRP transmission may refer to at least two TRPs (or panels) to transmit data to a UE. As shown in FIG. 1, for the same UE 105 (e.g., the UE 105a, the UE 105b, or the UE 105c), two TRPs (e.g., the TRP 103a and the TRP 103b) may both transmit data to it, which is an exemplary scenario of the multi-TRP transmission.

The UE 105 (for example, the UE 105a, the UE 105b, and the UE 105c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 105 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 105 may include wearable devices, such as smart watches, fitness bands, optical head-mounted displays, or the like. Moreover, the UE 105 may be referred to as a subscriber unit, a mobile, a mobile station, a user, a terminal, a mobile terminal, a wireless terminal, a fixed terminal, a subscriber station, a user terminal, or a device, or described using other terminology used in the art.

The BS 101 or the TRP 103 (one or multiple) may transmit a PDCCH carrying control information, e.g., downlink control information (DCI) to a UE 105. The UE 105 will perform blind decoding throughout candidates in a PDCCH search space set trying to find the PDCCH information (e.g., DCI). A PDCCH search space set consist of a set of PDCCH candidates formed by control channel elements (CCEs) at a given aggregation level, which a device, e.g., a UE is supposed to attempt to decode. A PDCCH search space set may also be termed as a search space set. Currently, there are two types of search space sets: the common search space (CSS) set and the UE specific search space (USS) set. A UE is required to monitor both the common search space set and UE specific search space set.

A search space set is associated with a CORESET and is configured by a radio resource control (RRC) signaling. A CORESET defines physical resources from which the search space set is defined and consists of a set of CCEs. For example, each CCE corresponds to 6 resource blocks (RBs) within the CORESET. From the network side point of view, multiple CCEs can be aggregated to transmit DCI, and the number of CCEs used for a DCI transmission is called a CCE aggregation level. For example, DCI transmitted using an aggregation level k means that k CCEs are aggregated for the transmission.

In radio access network (RAN) 1 #102 e-meeting, time division multiplexing (TDM), FDM, or single frequency network (SFN) based multiplexing schemes are agreed to be studied for multiple TRPs (mTRP) PDCCH reliability enhancement. In the other words, enhanced PDCCH transmission (or PDCCH transmission enhancement) includes non-SFN based enhanced PDCCH transmission and SFN based enhanced PDCCH transmission, wherein the non-SFN based enhanced PDCCH transmission further includes TDM based enhanced PDCCH transmission and FDM based enhanced PDCCH transmission. In particular, for the TDM based PDCCH transmission, two sets of symbols of the transmitted PDCCH, two non-overlapping (in time) transmitted PDCCH repetitions, or non-overlapping (in time) multi-chance transmitted PDCCH are associated with different TCI states. For the FDM based PDCCH transmission, resource elements corresponding to the same OFDM symbol may be grouped into resource element group (REG), and each CCE may include multiple REGs in one or more OFDM symbols; and two sets of REG bundles/CCEs of the transmitted PDCCH, two non-overlapping (in frequency) transmitted PDCCH repetitions, or non-overlapping (in frequency) multi-chance transmitted PDCCH are associated with different TCI states. The PDCCH transmission or PDCCH repetition described herein for enhanced PDCCH transmission may also be referred to as an ePDCCH transmission or ePDCCH.

In RAN1 104b e-meeting, for non-SFN enhanced PDCCH transmission, it is agreed to support identifying two QCL-TypeD properties for multiple CORESETs overlapping in the time domain. However, there is no discussion on the configuration and monitoring (or detecting) behaviour in the case of ePDCCH and CSI-RS in the same OFDM symbol, wherein a CORESET with two activated TCI state (or two different QCL-TypeDs) or two FDM-ed CORESETs may be used for enhanced PDCCH transmission. According to current 3GPP specification(s), ePDCCH (or PDCCH) and CSI-RS in the same OFDM symbol means that when UE is configured a CSI-RS resource and a search space set with a CORESET in the same OFDM symbol(s), UE assumes CSI-RS and PDCCH DM-RS transmitted in all search space sets associated with the CORESET are quasi co-located with QCL-TypeD.

At least for solving the above technical problems, embodiments of the present application provide a technical solution for PDCCH and CSI-RS (or CSI-RS resource) monitoring in the same time unit, especially for ePDCCH and CSI-RS in the same OFDM symbol(s) during multi-TRP transmission.

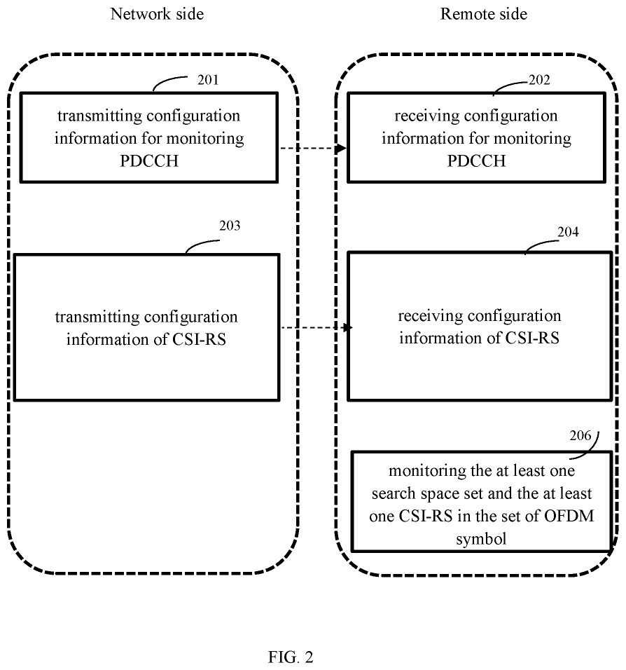

FIG. 2 illustrates a flow chart of a method for PDCCH and CSI-RS monitoring according to some embodiments of the present application. Although the method is illustrated in a system level by a UE in a remote side (or UE side) and a BS in a network side (or BS side), persons skilled in the art should understand that the method implemented in the remote side and that implemented in the network side can be separately implemented and incorporated by other apparatus with the like functions.

As shown in FIG. 2, in step 201, the network side, e.g., the BS 101 or TRP 103 as shown in FIG. 1 will transmit configuration information for monitoring PDCCH. The configuration information for monitoring PDCCH indicates at least one search space set configured in a set of OFDM symbols. Each search space set is associated with a CORESET, and different search space sets may be associated with the same or different CORESETs. Accordingly, the at least one search space set will be associated with a set of CORESET. Herein (throughout the specification), the wording “a set of” means “at least one” or “one or more” or the like wording. Accordingly, the remote side, e.g., the UE 105 as shown in FIG. 1 will receive the configuration information for monitoring PDCCH from the network side in step 202.

To support the capability of receiving transmission with multiple QCL-TypeDs in the same OFDM symbol(s) for a UE with multiple panels, PDCCH transmission is enhanced. For non-SFN based enhanced PDCCH with repetition, FDM-ed CORESETs can be configured, where each CORESET has one activated TCI state and thus may have different QCL-TypeDs if existed. Since TDM based enhanced PDCCH transmission does not have the concerned issue caused by the PDCCH and CSI-RS configured in the same OFDM symbol(s), it will not be discussed herein. For SFN based enhanced PDCCH transmission, one CORESET can be activated with two or more TCI states. For example, in a high speed train scenario, PDCCH can be transmitted with two activated TCI states from two TRPs, and tracking reference signal (TRS), which is a kind of CSI-RS and is a CSI-RS resource set, can be transmitted with one TCI state from one TRP.

Thus, for SFN based enhanced PDCCH with repetition, the set of CORESET associated with the at least one search space set at least includes a CORESET with a plurality of activated TCI states, e.g., 2 activated TCI states. For non-SFN based enhanced PDCCH transmission, the set of CORESET associated with the at least one search space set at least includes two FDM-ed CORESETs. As the development of 3GPP, the number of FDM-ed CORESETs in the same set of OFDM symbol may also change, and thus the set of CORESET associated with the at least one search space set may include more than two FDM-ed CORESETs.

In step 203, the network side may also transmit configuration information of CSI-RS, wherein the configuration information of CSI-RS indicates at least one CSI-RS configured in the set of OFDM symbol where the at least one search space set is configured. That is, the PDCCH (or search space set of PDCCH) and CSI-RS are configured in the same set of OFDM symbol, i.e., configured in one or more same OFDM symbols. Since the time granularity of an OFDM symbol in the network side and remote side may be the same or different considering the same or different subcarrier spacing, the same single OFDM symbol means the same single OFDM symbol with the smallest time granularity. That is, in the case the PDCCH and CSI-RS are configured in an identical OFDM symbol with the smallest granularity in one side of the network side and the remote side, the PDCCH and CSI-RS are deemed as being configured in the same OFDM symbol even for the corresponding OFDM symbol with larger granularity in the other side. Accordingly, in the remote side, the UE will receive the configuration information of CSI-RS from the network side in step 204.

For conventional schemes defined in current 3GPP specification(s), UE assumes CSI-RS and PDCCH DM-RS transmitted in all search space sets associated with the CORESET are quasi co-located with QCL-TypeD when UE is configured a CSI-RS resource and a search space set with a CORESET in the same OFDM symbol(s). That is, the CSI-RS resource and a search space set with a CORESET in the same OFDM symbol should have the same QCL-TypeD. Thus, how to configure or monitor CSI-RS in view of PDCCH monitoring with different QCL-TypeDs should be solved to support PDCCH monitoring with different QCL-TypeDs. At least considering that, the configuration information for monitoring PDCCH and configuration information of CSI-RS is configured based on one of the following: a configuration restriction rule on QCL-TypeD of CSI RS in view of CORESET in a same OFDM symbol; and a monitoring rule for monitoring PDCCH and CSI-RS with different QCL-TypeDs in a same OFDM symbol. Accordingly, in the remote side, in step 206, the UE will monitor the at least one search space set and the at least one CSI-RS in the set of OFDM symbol based on the configuration restriction rule or based on the monitoring rule. Since for PDCCH which does not satisfy with the monitoring rule, or a CSI-RS which does not satisfy with the configuration restriction rule or the monitoring rule, it will not be monitored according to the configuration restriction rule or the monitoring rule. For example, monitoring the at least one search space set and the at least one CSI-RS in the set of OFDM symbol based on the configuration restriction rule or based on the monitoring rule includes: monitoring both the at least one search space set and the at least one CSI-RS in the set of OFDM symbol which satisfy with the configuration restriction rule or the monitoring rule, only monitoring the at least one search space set while not monitoring the at least one CSI-RS in the set of OFDM symbol which does not satisfy with the configuration restriction rule, or not monitoring the at least one search space set which does not satisfy with the the monitoring rule while only monitoring the at least one CSI-RS in the set of OFDM symbol which satisfy with the monitoring rule etc. various cases. Accordingly, monitoring the at least one search space set and the at least one CSI-RS in the set of OFDM symbol based on the configuration restriction rule or based on the monitoring rule should not be limited to all the at least one search space set and the at least one CSI-RS in the set of OFDM symbol will be monitored.

An exemplary configuration restriction rule may define that: a QCL-TypeD of a CSI-RS to be monitored is as the same as one QCL-TypeD of a CORESET with a plurality of activated TCI states, e.g., 2 activated TCI states in the case that the CSI-RS and one or more search space sets associated with the CORESET are configured in the same OFDM symbol; or a QCL-TypeD of a CSI-RS to be monitored is as the same as a QCL-TypeD of a CORESET of a plurality of FDM-ed CORESETs in the case that the CSI-RS and one or more search space sets associated with the plurality of CORESETs are configured in the same OFDM symbol.

Another exemplary configuration restriction rule may define that: a QCL-TypeD of a CSI-RS to be monitored is as the same as a QCL-TypeD of a search space set with the highest priority of one or more search space sets in the case that the CSI-RS and the one or more search space sets are configured in the same OFDM symbol. In an embodiment of the present application, the exemplary configuration restriction rule may further define that the search space set with the highest priority is a common search space set with the lowest identity among common search space set(s) if existed, otherwise is a UE specific search space set among UE specific search space set(s) with the lowest identity.

An exemplary monitoring rule may define: monitoring PDCCH with assumption of a QCL-TypeD and monitoring CSI-RS with assumption of another QCL-TypeD. In an exemplary embodiment of the present application, the QCL-TypeD assumed for monitoring PDCCH is associated with a CSI-RS resource set or a SRS resource set and the other QCL-TypeD assumed for monitoring CSI-RS is associated with another CSI-RS resource sets or another SRS resource set.

Another exemplary monitoring rule may define: only monitoring PDCCH while not monitoring any CSI-RS with a QCL-TypeD different from the PDCCH in the same OFDM symbol. In an exemplary embodiment of the present application, in the case that a CSI-RS with the different QCL-TypeD is from a CSI-RS resource set, the monitoring rule may also define not monitoring any other CSI-RS of the CSI-RS resource set even if being configured in a different OFDM symbol.

In some yet other embodiments of the present application, the monitoring rule defines a priority list for monitoring PDCCH and CSI-RS. The monitoring rule may define a priority for monitoring PDCCH is higher than monitoring CSI-RS. According to some embodiments of the present application, elements of the priority list may include a plurality of CSI-RSs, and a plurality of CORESETs or a plurality of search space sets. The monitoring rule may define that in the case that more than one search space set of the plurality of search space sets is linked, the more than one search space set has the same priority.

In the case that a UE does not have the capability of receiving with different QCL-TypeDs in the same OFDM symbol, the configuration restriction rule and monitoring rule illustrated in embodiments of the present application will fall back the those defined in Rel.15. In some embodiments of the present application, UE may report its capability by a capability signaling to the network side, e.g., to a gNB, indicating whether capable of receiving with different QCL-TypeDs in one or more same OFDM symbols in the UE. Furthermore, this capability signaling can be refined to be whether capable of receiving with different QCL-TypeDs for PDCCH only or receiving with different QCL-TypeDs for PDCCH and CSI-RS.

More detailed embodiments will be illustrated in view of different configuration restriction rules and monitoring rules in different scenarios. Meanwhile, considering the consistency between the network side and the remote side, although the following descriptions are provided mainly concerning on one side, e.g., the remote side for simplification, persons skilled in the art should well understand the corresponding operations in the network side.

As stated above, SFN based PDCCH transmission with multiple, e.g., two activated TCI states and PDCCH with repetition transmission on FDM-ed CORESETS (FDM based PDCCH transmission with repetition) can be configured to enhance PDCCH transmission to improve reliability. In any of the above two kinds of PDCCH transmission, PDCCH will be transmitted with two or more TCI states in the same OFDM symbol(s) and will be monitored by UE with assumed two or more TCI states.

According to some embodiments of the present application, to support CSI-RS transmitted with ePDCCH in the same OFDM symbol(s), the configuration requirement defined by current 3GPP specification(s) that the same QCL-TypeD assumed between CSI-RS and CORESETs (or search space set) in the same OFDM symbol will be changed according to some embodiments of the present application. Based on the change, UE will expect that the QCL-TypeD of CSI-RS is the same as one of multiple QCL-TypeDs of CORESET(s) for enhanced PDCCH transmission in the case that at least one CSI-RS and PDCCH transmission with multiple QCL-TypeDs are configured in the same symbol(s).

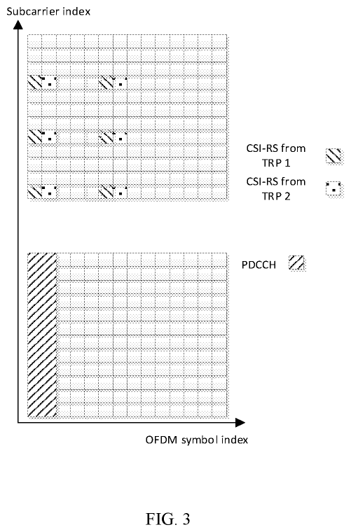

FIG. 3 is a schematic diagram illustrating exemplary PDCCH and CSI-RS configured in the same set of OFDM symbol based on a configuration restriction rule according to some embodiments of the present application.

As shown in FIG. 3, exemplary configuration information of PDCCH transmission indicates a plurality of search space sets configured in a set of OFDM symbol, e.g., the first two OFDM symbols in FIG. 3, wherein each block in the direction of OFDM symbol index represents one OFDM symbol, hereafter the same.

To support PDCCH with different QCL-TypeDs considering two receiving panels in the UE side, in the case that the PDCCH transmission shown in FIG. 3 is a SFN based PDCCH transmission with two activated TCI states, the plurality of search space sets are associated with the same CORESET with two activated TCI states, e.g., TCI state 1 and TCI state 2, wherein TCI state 1 includes QCL-TypeD 1 and TCI state 2 includes QCL-TypeD 2. In the case that the PDCCH transmission shown in FIG. 3 is a PDCCH with repetition transmission on FDM-ed CORESETs, the plurality of search space sets are associated with two FDM-ed CORESETs with two activated TCI states, e.g., one CORESET with TCI state 1 including QCL-TypeD 1 and another CORESET with TCI state 2 including QCL-TypeD 2. Whatever, the PDCCH in FIG. 3 is configured with two QCL-TypeDs, i.e., QCL-TypeD 1 and QCL-TypeD 2.

In addition, exemplary configuration information of CSI-RS indicates CSI-RS resources from a TRP, e.g., a TRS including a set of CSI-RS resources from TRP 1 in the first OFDM symbol and the sixth OFDM symbol. The exemplary configuration information of CSI-RS also indicates CSI-RS resources from another TRP. e.g., a TRS including a set of CSI-RS resources from TRP 2 in the second OFDM symbol and seventh OFDM symbol. In addition, for a CSI-RS resource set, e.g., a TRS, all CSI-RS resource in the CSI-RS resource set will be transmitted or monitored in the case that one of them will be transmitted or monitored.

To ensure the CSI-RS resources from TRP 1 and TRP 2 can be monitored simultaneously with the PDCCH transmission in the same OFDM symbols, the configuration information of CSI-RS will be made based on a configuration restriction rule according to some embodiments of the present application. For example, considering a scenario of SFN based PDCCH transmission with two activated TCI states, an exemplary configuration restriction rule may define that: a QCL-TypeD of a CSI-RS to be monitored is as the same as one QCL-TypeD of a CORESET with two activated TCI states in the case that the CSI-RS and one or more search space sets associated with the CORESET are configured in the same OFDM symbol. In another example, considering a scenario of PDCCH with repetition transmission on FDM-ed CORESETs, an exemplary configuration restriction rule may define that: a QCL-TypeD of a CSI-RS to be monitored is as the same as a QCL-TypeD of a CORESET of a plurality of FDM-ed CORESETs in the case that the CSI-RS and one or more search space sets associated with the plurality of CORESETs are configured in the same OFDM symbol(s).

Thus, based on the above configuration restriction rule, CSI-RS resources of the TRS from TRP 1 in the first symbol can be configured to be associated with TCI state 1 including QCL-TypeD 1, and the CSI-RS resources of the TRS resource from TRP 2 in the second OFDM symbol can be configured associated with TCI state 2 including QCL-TypeD 2. Accordingly, CSI-RS resources of the TRS from TRP 1 can be monitored simultaneously with PDCCH in the first OFDM symbol due to both with QCL-TypeD 1, and CSI-RS-RS resources of the TRS from TRP 2 can be monitored simultaneously with PDCCH in the second OFDM symbol due to both with QCL-TypeD 2. In addition, other CSI-RS resources of the TRS from TRP 1 and TRP 2 will also be transmitted or monitored in the corresponding OFDM symbols.

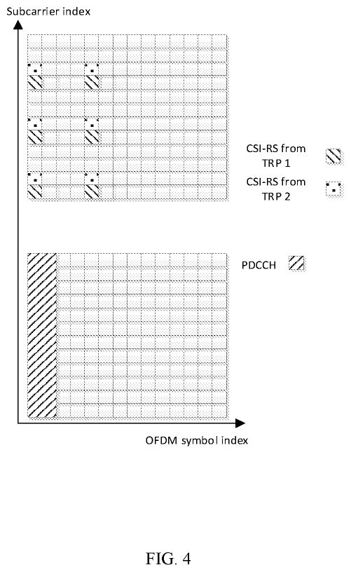

FIG. 4 is a schematic diagram illustrating exemplary PDCCH and CSI-RS configured in the same set of OFDM symbol based on a configuration restriction rule according to some other embodiments of the present application.

As shown in FIG. 4, exemplary configuration information of a PDCCH transmission indicates a plurality of search space sets configured in a set of OFDM symbol, e.g., the first two OFDM symbols in FIG. 4. Similar to the scenario shown in FIG. 3, the PDCCH in FIG. 4 is configured with two QCL-TypeDs, i.e., QCL-TypeD 1 and QCL-TypeD 2. Specifically, in the case that the PDCCH transmission is a SFN based PDCCH transmission with two activated TCI states, the plurality of search space sets are associated with the same CORESET with two activated TCI states, e.g., TCI state 1 including QCL-TypeD 1 and TCI state 2 including QCL-TypeD 2. In the case that the PDCCH transmission is a PDCCH with repetition transmission on FDM-ed CORESETs, the plurality of search space sets are associated with two FDM-ed CORESETs with two activated TCI states, e.g., one CORESET with TCI state 1 including QCL-TypeD 1 and another CORESET with TCI state 2 including QCL-TypeD 2.

In addition, exemplary configuration information of CSI-RS indicates CSI-RS resources from a TRP, e.g., a TRS including a set of CSI-RS resources from TRP 1 in the first OFDM symbol and the fifth OFDM symbol. The exemplary configuration information of CSI-RS also indicates CSI-RS resources from another TRP. e.g., a TRS including a set of CSI-RS resources from TRP 2 in the first OFDM symbol and fifth OFDM symbol. In addition, for a CSI-RS resource set, e.g., a TRS, all CSI-RS resource in the CSI-RS resource set will be transmitted or monitored in the case that one of them will be transmitted or monitored.

Similarly, based on the above configuration restriction rule as illustrated in the embodiments associated with FIG. 3, the TRS from TRP 1 can be configured to be associated with TCI state 1 including QCL-TypeD 1, and the TRS from TRP 2 can be configured to be associated with TCI state 2 including QCL-TypeD 2. Accordingly, CSI-RS resources of the TRS from TRP 1 with QCL-TypeD 1 can be monitored simultaneously with PDCCH in the first OFDM symbol due to both with QCL-TypeD 1, and CSI-RS-RS resources of the TRS from TRP 2 with the QCL-TypeD 2 can also be monitored simultaneously with PDCCH in the first OFDM symbol due to both with QCL-TypeD 2. In addition, other CSI-RS resources of the TRS from TRP 1 and TRP 2 will also be transmitted or monitored in the corresponding OFDM symbols.

Embodiments of FIGS. 3 and 4 only illustrate simple scenarios, where PDCCH(s) is from only one CORESET with multiple TCI states, or multiple FDM-ed CORESETs with the same TCI state. However, in more complicated scenarios, in the same set of OFDM symbol where both PDCCH(s) and CSI-RS(s) are configured, more CORESETs with more TCI states can be configured for the PDCCH.

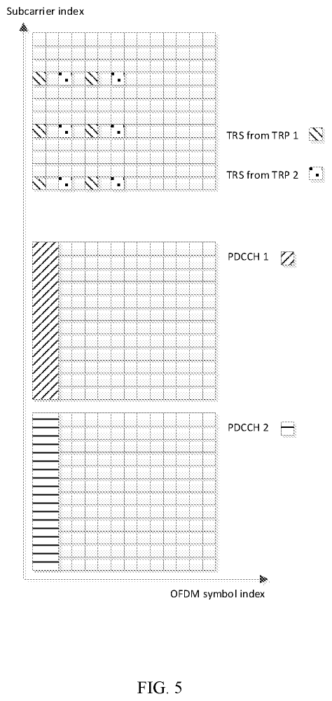

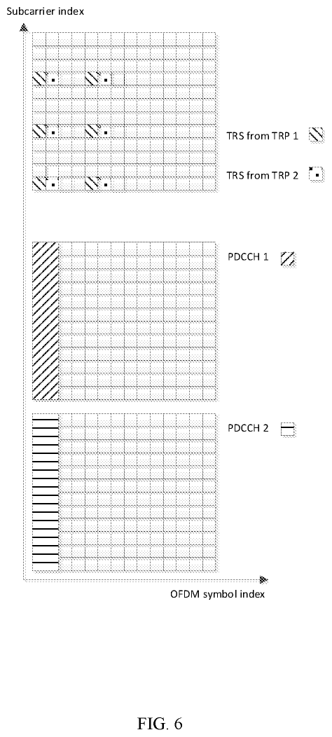

FIG. 5 and FIG. 6 both are schematic diagrams illustrating exemplary PDCCH and CSI-RS configured in the same set of OFDM symbol based on a configuration restriction rule according to some other embodiments of the present application. FIG. 5 and FIG. 6 only differ in the multiplexing schemes between CSI-RS and PDCCH in the same OFDM symbol(s).

As shown in FIGS. 5 and 6, CORESET 1 is used for common PDCCH transmission, e.g., PDCCH 1 with one activated TCI state, e.g., TCI state 1 including QCL-TypeD 1, CORESET 2 is used for UE specific PDCCH transmission, e.g., PDCCH 2 with 2 activated TCI states, e.g., TCI 2 including QCL-TypeD 2 and QCL-TypeD 3. The search space sets corresponding to CORESET 1 and CORESET 2 may happen to be configured in the same set of OFDM symbol, e.g., the first OFDM symbol in FIG. 5 and the first two OFDM symbols in 6.

In addition, exemplary configuration information of CSI-RS indicates CSI-RS resources from different TRPs. For example, in FIG. 5, the configuration information of CSI-RS indicates a TRS including a set of CSI-RS resources from TRP 1 in the first and fifth OFDM symbols, and a TRS including a set of CSI-RS resources from TRP 2 in the third and the seventh OFDM symbols. In FIG. 6, the configuration information of CSI-RS indicates a TRS including a set of CSI-RS resources from TRP 1 in the first and fifth OFDM symbols, and a TRS including a set of CSI-RS resources from TRP 2 in the second and the sixth OFDM symbols.

According to current 3GPP specification(s), it is impossible to configure CSI-RS in the same OFDM symbol(s) with PDCCH from CORESET 1 and CORESET 2 simultaneously because CSI-RS should have the same QCL-TypeD as all the search space sets of CORESETs in the same OFDM symbol(s). Thus, to exploit UE's capability of receiving transmission with multiple QCL-TypeDs, this issue should also be solved in such complicated scenarios.

According to some embodiments of the present application, the above configuration restriction rule as illustrated in FIGS. 3 and 4 can also be used in such complicated scenarios as shown in FIGS. 5 and 6. Thus, in FIG. 5, since the TRS from TRP 1 has CSI-RS resources in the first OFDM symbol, it will be configured to have QCL-TypeD 1 as the same as CORESET 1, or as the same as one of CORESET 2, e.g., QCL-TypeD 2 or QCL-TypeD 3. Since the TRS from TRP 2 has no CSI-RS resource configured in the same OFDM sybol as PDCCH transmission in the first two OFDM symbols, there is no configuration resctrion on the QCL-TypeD of the TRS from TRP 2. Similarly, both the TRS from TRP 1 and TRS from TRP 2 have CSI-RS resources in the same OFDM symbols as the PDCCH transmission in the first two OFDM symbols in FIG. 6, their QCL-TypeDs will be configured based on the configuration restriction rule. For example, the TRS from TRP 1 having CSI-RS resources in the first OFDM symbol, may be configured to have QCL-TypeD 1 as the same as CORESET 1; and the TRS from TRP 2 having CSI-RS resources in the second OFDM symbol, may be configured to have QCL-TypeD 2 or QCL-TypeD 3 as the same as that of CORESET 2, and vice versa.

According to some other embodiments of the present application, another configuration restriction rule may be applied to such complicated scenarios as shown in FIGS. 5 and 6, which defines that: a QCL-TypeD of a CSI-RS to be monitored is as the same as a QCL-TypeD of a search space set with a highest priority of one or more search space sets in the case that the CSI-RS and the one or more search space sets are configured in the same OFDM symbol.

For example, the QCL-TypeD for CSI-RS is limited to the QCL information of the search space set with the highest priority configured for PDCCH. UE expect the CSI-RS(s) to be monitored has the same QCL-TypeD(s) as that of the associated CORESET(s) from which the search space set with the highest priority is. The search space set with the highest priority is the search space set with the lowest ID from common search space set if existed, otherwise, is the search space set with the lowest ID from UE specific search space set. Only the search space sets with the highest priority will be monitored and other search space set(s) may be not monitored or be discarded.

According to the configuration restriction rule, the restriction is used to align the QCL-TypeD for a CSI-RS with that for PDCCH. However, according to some embodiments of the present application, the configuration restriction rule may be relaxed for different QCL-TypeDs for PDCCH and CSI-RS in the same OFDM symbol(s). That is, based on UE's capability for receiving transmission simultaneously with multiple QCL-TypeDs, the network side can flexibly configure CSI-RS and PDCCH, and a monitoring rule will be applied to make them be monitored (or received) simultaneously in the remote side.

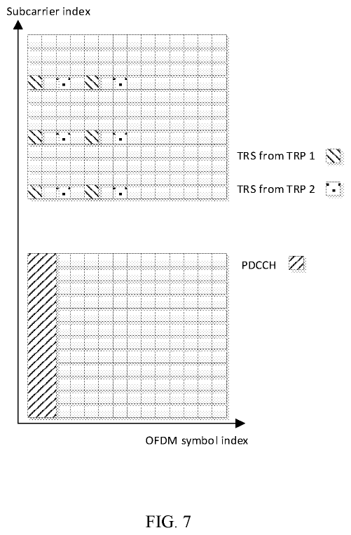

FIG. 7 is a schematic diagram illustrating exemplary PDCCH and CSI-RS configured in the same set of OFDM symbol based on a monitoring rule according to some embodiments of the present application.

As an example shown in FIG. 7, exemplary configuration information of a PDCCH transmission indicates a plurality of search space sets configured in a set of OFDM symbol, e.g., the first two OFDM symbols. Similarly, to support PDCCH monitoring with different QCL-TypeDs considering multiple panels at the UE side, in the case that the PDCCH transmission is a SFN based PDCCH transmission with two activated TCI states, the plurality of search space sets are associated with the same CORESET with two activated TCI states, e.g., TCI state 1 and TCI state 2, wherein TCI state 1 includes QCL-TypeD 1 and TCI state 2 includes QCL-TypeD 2. In the case that the PDCCH transmission is a PDCCH with repetition transmission on FDM-ed CORESETs, the plurality of search space sets are associated with two FDM-ed CORESETs with two activated TCI states, e.g., TCI state 1 and TCI state 2, wherein TCI state 1 includes QCL-TypeD 1 and TCI state 2 includes QCL-TypeD 2.

The configuration information of CSI-RS indicates a TRS including a set of CSI-RS resources from TRP 1 in the first and fifth OFDM symbol, and a TRS including a set of CSI-RS resources from TRP 2 in the third and the seventh OFDM symbols. In addition, although the TRS from TRP 1 has CSI-RS resources configured in the first OFDM symbol, i.e., being configured in the same OFDM symbol as the PDCCH, the QCL-TypeD for the TRS from TRP 1 is different from that for the PDCCH.

In some embodiments of the present application, the monitoring rule may define only monitoring PDCCH while not monitoring any CSI-RS with a QCL-TypeD different from the PDCCH in the same OFDM symbol. In the case that a CSI-RS with the different QCL-TypeD is from a CSI-RS resource set, the monitoring rule also defines not monitoring any other CSI-RS of the CSI-RS resource set even if being configured in a different OFDM symbol.

Based on such as a monitoring rule, although the network side transmits CSI-RS with different QCL-TypeD in the same set of OFDM symbols as PDCCH with 2 activated TCI states, the CSI-RS will be not detected by the UE. The UE will only monitor the PDCCH with the two QCL-TypeD assumption. That is, all the receiving panels of the UE will be used to receive the PDCCH. The UE is not expected to receive other CSI-RS in the same CSI-RS resource set for time frequency tracking to guarantee the tracking accuracy. For the scenario as shown in FIG. 7, the UE only monitors PDCCH from a CORESET with two different QCL-TypeDs but does not detect the TRS from TRP 1, which includes all CSI-RS resources of the TRS from TRP 1.

According to some other embodiments of the present application, for a UE with multiple panels, e.g., two panels, it may receive PDCCH with one panel and receive CSI-RS with another panel. That is, the network side, e.g., a gNB will transmit PDCCH from one TRP in a fallback mode and transmit CSI-RS from another TRP. Accordingly, the UE will fall back to a single panel receiving mode for PDCCH. The UE will monitor PDCCH with assumption of one QCL-TypeD and detects CSI-RS with assumption of another QCL-TypeD.

To differentiate different panels associated with different QCL-TypeDs, the QCL-TypeD assumed for monitoring PDCCH may be associated with a CSI-RS resource set or a SRS resource set and the other QCL-TypeD assumed for monitoring CSI-RS may be associated with another CSI-RS resource sets or another SRS resource set. For example, each QCL-TypeD for CSI-RS and PDCCH can be linked (or associated) with a CSI-RS resource set index or SRS resource set index, e.g., set index “0” denoting panel 1 and set index “1” denoting panel 2. In another example, it can be realized by an implicit linkage manner, e.g., a CSI-RS or SRS resource set being implicitly associated with a panel, and accordingly, the panel assumed for receiving PDCCH can be implicitly determined by the association between the CSI-RS (or SRS) resource set and PDCCH, and the panel assumed for receiving PDCCH can be implicitly determined by the association between the CSI-RS (or SRS) resource set and CSI-RS.

In some cases, the total QCL-TypeD number for PDCCH and CSI-RS may exceed the maximum number supported by the UE capability. To solve that, the monitoring rule according some embodiments of the present application may provide the monitoring priority for monitoring PDCCH (i.e., monitoring search space set(s) from CORESET(s) for the PDCCH) and CSI-RS.

In some embodiments of the present application, the monitoring rule may generally define that a priority for monitoring PDCCH is always higher than that for monitoring CSI-RS in the case that the total QCL-TypeD number for PDCCH and CSI-RS exceeds the maximum number supported by the UE capability, e.g. two.

In some embodiments of the present application, the monitoring rule may define a priority list for monitoring PDCCH and CSI-RS to achieve flexible multiplexing. According to the monitoring rule, the network side will configure a priority list for monitoring among PDCCH from CORESETs (or search space sets) and CSI-RS. The network side will configure the PDCCH and CSI-RS according to the monitoring rule, and the UE will perform monitoring based on the monitoring priority list. According to some embodiments of the present application, the monitoring rule may also define that in the case that more than one search space set of the plurality of search space sets is linked, the more than one search space set has the same priority. For example, for the TRS from TRP 1 as shown in FIG. 7, the CSI-RS resources in the first OFDM symbols and those in the fifth CSI-RS resources in the fifth OFDM symbols have the same priority. That is the same for the TRS from TRP 2 as shown in FIG. 7.

Elements of the priority list may include a plurality of CSI-RSs, and a plurality of CORESETs or a plurality of search space sets for PDCCH. For example, an exemplary priority list may be: {PDCCH from CORESET (or search space set) m including the associated CORESET (or search space set) if existed, PDCCH from CORESET (or search space set) n including the associated CORESET (or search space set) if existed, CSI-RS resource k. CSI-RS resource 1}, wherein m and n are CORESET (or search space set) indexes, k and 1 are CSI-RS resource indexes.

For the priority list, the monitoring rule may define that a priority for monitoring PDCCH is higher than that for monitoring CSI-RS. For example, to monitor CSI-RS resource with higher priority relative to UE specific PDCCH and lower priority relative to common PDCCH, an exemplary priority list may be: {PDCCH from CORESET (search space set) m including the associated CORESET (search space set) if existed, CSI-RS resource k, PDCCH from CORESET (search space set) n including the associated CORESET (search space set) if existed, CSI-RS resource 1}. In the exemplary priority list, CSI-RS resource k has a higher priority than UE specific PDCCH from CORESET (search space set) n while has a lower priority than common PDCCH from CORESET (search space set) m.

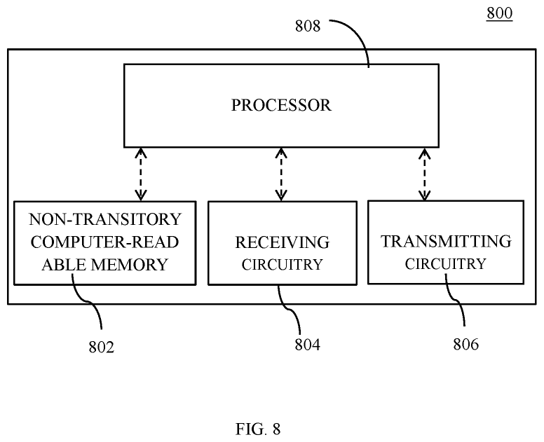

Embodiments of the present application also propose an apparatus for PDCCH and CSI-RS monitoring. For example, FIG. 8 illustrates a block diagram of an apparatus 800 for PDCCH and CSI-RS monitoring according to some embodiments of the present application.

As shown in FIG. 8, the apparatus 800 may include at least one non-transitory computer-readable medium 801, at least one receiving circuitry 802, at least one transmitting circuitry 804, and at least one processor 806 coupled to the non-transitory computer-readable medium 801, the receiving circuitry 802 and the transmitting circuitry 804. The apparatus 800 may be a network side apparatus (e.g., a BS) configured to perform a method illustrated in any one of FIGS. 2-7 and the like, or a remote unit (e.g., a UE) configured to perform a method illustrated in any one of FIGS. 2-7 or the like.

Although in this figure, elements such as the at least one processor 806, transmitting circuitry 804, and receiving circuitry 802 are described in the singular, the plural is contemplated unless a limitation to the singular is explicitly stated. In some embodiments of the present application, the receiving circuitry 802 and the transmitting circuitry 804 can be combined into a single device, such as a transceiver. In certain embodiments of the present application, the apparatus 800 may further include an input device, a memory, and/or other components.

For example, in some embodiments of the present application, the non-transitory computer-readable medium 801 may have stored thereon computer-executable instructions to cause a processor to implement the method with respect to the UE as described above. For example, the computer-executable instructions, when executed, cause the processor 806 interacting with receiving circuitry 802 and transmitting circuitry 804, so as to perform the steps with respect to the UE depicted in FIG. 2.

In some embodiments of the present application, the non-transitory computer-readable medium 801 may have stored thereon computer-executable instructions to cause a processor to implement the method with respect to the BS as described above. For example, the computer-executable instructions, when executed, cause the processor 806 interacting with receiving circuitry 802 and transmitting circuitry 804, so as to perform the steps with respect to the BS depicted in FIG. 2.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for PDCCH and CSI-RS monitoring, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including.” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A method performed by a user equipment (UE), the method comprising:
receiving configuration information for monitoring physical downlink control channel (PDCCH), the configuration information for monitoring PDCCH indicating at least one search space set configured in a set of orthogonal frequency division multiplexing (OFDM) symbols, and a set of one or more control resource sets (CORESETs) associated with the at least one search space set includes at least a control resource set (CORESET) with a plurality of activated transmission configuration indication (TCI) states or two frequency division multiplexing (FDM)-ed CORESETs;
receiving configuration information of channel state information (CSI)-reference signal (RS), the configuration information of CSI-RS indicating at least one CSI-RS configured in the set of OFDM symbols; and
monitoring the at least one search space set and the at least one CSI-RS in the set of OFDM symbols based on one of:
a configuration restriction rule on quasi co-location (QCL)-TypeD of CSI RS in view of CORESET in a same OFDM symbol; and
a monitoring rule for monitoring PDCCH and CSI-RS with different QCL-TypeDs in the same OFDM symbol.

2-13. (canceled)

14. A base station for wireless communication, comprising:
at least one memory; and
at least one processor coupled with the at least one memory and configured to cause the base station to:
transmit configuration information for monitoring physical downlink control channel (PDCCH), the configuration information for monitoring PDCCH indicating at least one search space set configured in a set of orthogonal frequency division multiplexing (OFDM) symbols, and a set of one or more control resource sets (CORESETs) associated with the at least one search space set includes at least a control resource set (CORESET) with a plurality of activated transmission configuration indication (TCI) states or two frequency division multiplexing (FDM)-ed CORESETs;
transmit configuration information of channel state information (CSI)-reference signal (RS), the configuration information of CSI-RS indicating at least one CSI-RS configured in the set of OFDM symbols;
the configuration information for monitoring PDCCH and configuration information of CSI-RS being configured based on one of:
a configuration restriction rule on quasi co-location (QCL)-TypeD of CSI RS in view of CORESET in a same OFDM symbol; and
a monitoring rule for monitoring PDCCH and CSI-RS with different QCL-TypeDs in the same OFDM symbol.

15. A user equipment (UE) for wireless communication, comprising:
at least one memory; and
at least one processor coupled with the at least one memory and configured to cause the UE to:
receive configuration information for monitoring physical downlink control channel (PDCCH), the configuration information for monitoring PDCCH indicating at least one search space set configured in a set of orthogonal frequency division multiplexing (OFDM) symbols, and a set of one or more control resource sets (CORESETs) associated with the at least one search space set includes at least a control resource set (CORESET) with a plurality of activated transmission configuration indication (TCI) states or two frequency division multiplexing (FDM)-ed CORESETs;
receive configuration information of channel state information (CSI)-reference signal (RS), the configuration information of CSI-RS indicating at least one CSI-RS configured in the set of OFDM symbols; and
monitor the at least one search space set and the at least one CSI-RS in the set of OFDM symbols based on one of:
a configuration restriction rule on quasi co-location (QCL)-TypeD of CSI RS in view of CORESET in a same OFDM symbol; and
a monitoring rule for monitoring PDCCH and CSI-RS with different QCL-TypeDs in the same OFDM symbol.

16. The UE of claim 15, wherein the configuration restriction rule defines that:
a QCL-TypeD of a CSI-RS to be monitored is a same QCL-TypeD as one QCL-TypeD of a CORESET with a plurality of active TCI states in a case that the CSI-RS and one or more search space sets associated with the CORESET are configured in the same OFDM symbol; or
a QCL-TypeD of a CSI-RS to be monitored is as the same QCL-TypeD as a QCL-TypeD of a CORESET of a plurality of FDM-ed CORESETs in the case that the CSI-RS and one or more search space sets associated with the plurality of CORESETs are configured in the same OFDM symbol.

17. The UE of claim 15, wherein the configuration restriction rule defines that:
a QCL-TypeD of a CSI-RS to be monitored is a same QCL-TypeD as a QCL-TypeD of a search space set with a highest priority of one or more search space sets in a case that the CSI-RS and the one or more search space sets are configured in the same OFDM symbol.

18. The UE of claim 17, wherein the search space set with the highest priority is a common search space set with a lowest identity if existed, otherwise is a UE specific search space set with a lowest identity.

19. The UE of claim 15, wherein the monitoring rule defines:
monitoring PDCCH with assumption of a QCL-TypeD and monitoring CSI-RS with assumption of another QCL-TypeD.

20. The UE of claim 19, wherein the QCL-TypeD assumed for monitoring PDCCH is associated with a CSI-RS resource set or a sounding reference signal (SRS) resource set and the other QCL-TypeD assumed for monitoring CSI-RS is associated with another CSI-RS resource set or another SRS resource set.

21. The UE of claim 15, wherein the monitoring rule defines only monitoring PDCCH while not monitoring any CSI-RS with a QCL-TypeD different from the PDCCH in the same OFDM symbol.

22. The UE of claim 21, wherein in a case that a CSI-RS with the different QCL-TypeD is from a CSI-RS resource set, the monitoring rule also defines not monitoring any other CSI-RS of the CSI-RS resource set even if being configured in a different OFDM symbol.

23. The UE of claim 15, wherein the monitoring rule defines a priority list for monitoring PDCCH and CSI-RS.

24. The UE of claim 23, wherein elements of the priority list comprise a plurality of CSI-RSs, and a plurality of CORESETs or a plurality of search space sets.

25. The UE of claim 24, wherein in a case that more than one search space set of the plurality of search space sets are linked, the more than one search space sets have a same priority.

26. The UE of claim 23, wherein the monitoring rule defines a priority for monitoring PDCCH is higher than monitoring CSI-RS.

27. The UE of claim 15, wherein the at least one processor is configured to cause the UE to: report a capability signaling indicating whether the UE is capable of receiving with different QCL-TypeDs in one or more same OFDM symbols.

28. A processor for wireless communication, comprising:
at least one controller coupled with at least one memory and configured to cause the processor to:
receive configuration information for monitoring physical downlink control channel (PDCCH), the configuration information for monitoring PDCCH indicating at least one search space set configured in a set of orthogonal frequency division multiplexing (OFDM) symbols, and a set of one or more control resource sets (CORESETs) associated with the at least one search space set includes at least a control resource set (CORESET) with a plurality of activated transmission configuration indication (TCI) states or two frequency division multiplexing (FDM)-ed CORESETs;
receive configuration information of channel state information (CSI)-reference signal (RS), the configuration information of CSI-RS indicating at least one CSI-RS configured in the set of OFDM symbols; and
monitor the at least one search space set and the at least one CSI-RS in the set of OFDM symbols based on one of:
a configuration restriction rule on quasi co-location (QCL)-TypeD of CSI RS in view of CORESET in a same OFDM symbol; and
a monitoring rule for monitoring PDCCH and CSI-RS with different QCL-TypeDs in the same OFDM symbol.

29. The processor of claim 28, wherein the configuration restriction rule defines that:
a QCL-TypeD of a CSI-RS to be monitored is a same QCL-TypeD as one QCL-TypeD of a CORESET with a plurality of active TCI states in a case that the CSI-RS and one or more search space sets associated with the CORESET are configured in the same OFDM symbol; or
a QCL-TypeD of a CSI-RS to be monitored is as the same QCL-TypeD as a QCL-TypeD of a CORESET of a plurality of FDM-ed CORESETs in the case that the CSI-RS and one or more search space sets associated with the plurality of CORESETs are configured in the same OFDM symbol.

30. The processor of claim 28, wherein the configuration restriction rule defines that:
a QCL-TypeD of a CSI-RS to be monitored is a same QCL-TypeD as a QCL-TypeD of a search space set with a highest priority of one or more search space sets in a case that the CSI-RS and the one or more search space sets are configured in the same OFDM symbol.

31. The processor of claim 28, wherein the monitoring rule defines:
monitoring PDCCH with assumption of a QCL-TypeD and monitoring CSI-RS with assumption of another QCL-TypeD.

32. The processor of claim 28, wherein the monitoring rule defines only monitoring PDCCH while not monitoring any CSI-RS with a QCL-TypeD different from the PDCCH in the same OFDM symbol.
